(19) United States
(12) Patent Application Publication
(10) Pub. No.: US 2019/0376907 A1
(43) Pub. Date: Dec. 12, 2019

(54) LIGHT-SCATTERING DUST SENSOR

(71) Applicant: SAMYOUNG S&C CO., LTD., Gyeonggi-do (KR)

(72) Inventors: Sang Ick Park, Seoul (KR); Do Hoon Kim, Gyeonggi-do (KR); Hyun Chul Hwang, Gyeonggi-do (KR); Myeong Yong Lee, Gyeonggi-do (KR); Dong Ju Kim, Gyeonggi-do (KR)

(21) Appl. No.: 16/217,571

(22) Filed: Dec. 12, 2018

(30) Foreign Application Priority Data
Jun. 11, 2018 (KR) 10-2018-0067036

(51) Int. Cl. G01N 21/94; G01N 21/47; G01N 15/06

(52) U.S. Cl. CPC G01N 21/94; G01N 15/0656; G01N 21/47

(57) ABSTRACT

A light-scattering dust sensor includes: a light scattering region; a light emitter configured to emit light to the light scattering region; a light receiver configured to receive scattered light generated in the light scattering region; and an emitted light limiter located between the light emitter and the light scattering region, wherein the light emitted by the light emitter includes: peripheral light; and central light having an intensity that is more uniform than an intensity of the peripheral light, wherein the emitted light limiter is configured to block part of the emitted light, wherein the part of the emitted light blocked by the emitted light limiter includes the peripheral light.

### CROSS-REFERENCE TO RELATED APPLICATION

This application claims the benefit of Korean Patent Application No. 10-2018-0067036, filed on Jun. 11, 2018, in the Korean Intellectual Property Office, the disclosure of which is incorporated herein in its entirety by reference.

### BACKGROUND

### 1. Field

One or more embodiments relate to a light-scattering dust sensor.

### 2. Description of the Related Art

Dust is a material which greatly affects the human body. Dust is likely to adversely affect the human body, such as by increasing the incidence of disease and mortality among vulnerable groups. In order to cope with the dangers of dust, the demand for dust sensors having high performance has increased.

In general, a dust sensor using a light scattering method detects light scattered by dust and measures the amount of dust. An inexpensive light-scattering dust sensor mainly uses a light-emitting diode (LED) as a light source. When the LED is a predetermined distance away from the center of light, the degree and uniformity of light intensity may decrease. Accordingly, the intensity of scattered light generated from dust particles may vary according to which portion of light emitted from the LED is exposed to the dust particles.

### SUMMARY

One or more embodiments include a dust sensor having improved precision and reliability.

Additional aspects will be set forth in part in the description which follows and, in part, will be apparent from the description, or may be learned by practice of the presented embodiments.

According to one or more embodiments, a light-scattering dust sensor includes: a light scattering region: a light emitter configured to emit light to the light scattering region; a light receiver configured to receive scattered light generated in the light scattering region; and an emitted light limiter located between the light emitter and the light scattering region, wherein the light emitted by the light emitter includes: peripheral light; and central light having an intensity that is more uniform than an intensity of the peripheral light, wherein the emitted light limiter is configured to block part of the emitted light, wherein the part of the emitted light blocked by the emitted light limiter includes the peripheral light.

The emitted light limiter may include a slit or an aperture.

The slit or the aperture may have a size equal to or less than a width of the central light.

The light emitter may include a light-emitting diode (LED).

The width of the central light may be equal to or less than a width of light determined by a half angle of the LED.

The light-scattering dust sensor may further include a scattered light limiter located between the light receiver and the light scattering region, wherein the scattered light limiter is configured to block part of the scattered light, and the light receiver is further configured to detect another part of the scattered light.

The scattered light limiter may include a plurality of hole structures sequentially arranged from the light scattering region to the light receiver, wherein the plurality of hole structures respectively include a plurality of holes having different sizes.

From among the plurality of holes, a hole adjacent to the light receiver may be smaller than a hole adjacent to the light scattering region.

The plurality of holes may be three holes.

The light-scattering dust sensor may further include a scattered light focusing lens located between the scattered light limiter and the light scattering region, wherein the scattered light focusing lens is configured to focus the scattered light such that the focused light is provided to the receiver.

The light-scattering dust sensor may further include a heater configured to generate heat and thereby move dust particles.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view of a dust sensor according to embodiments;

FIG. 2 is a cross-sectional view for describing a driving mode of a dust sensor that does not include an emitted light limiter;

FIG. 3 is a cross-sectional view for describing a driving mode of the dust sensor of FIG. 1;

FIG. 4 is a cross-sectional view of a dust sensor according to embodiments; and

FIG. 5 is a cross-sectional view of a dust sensor according to embodiments.

### DETAILED DESCRIPTION

The present disclosure will now be described more fully with reference to the accompanying drawings, in which embodiments are shown. The same reference numerals in the drawings denote the same elements, and sizes of elements in the drawings may be exaggerated for clarity and convenience of explanation. Also, exemplary embodiments are described, and various modifications may be made from the embodiments.

It will also be understood that when a layer is referred to as being “on” another layer or substrate, it may be directly on the other layer or substrate, or intervening layers may also be present

As used herein, the singular forms “a”, “an”, and “the” are intended to include the plural forms as well, unless the context clearly indicates otherwise. Throughout the specification, when a portion “includes” an element, another element may be further included, rather than excluding the existence of the other element, unless otherwise described.

Terms such as “ . . . unit” refer to units that perform at least one function or operation, and the units may be implemented as hardware or software or as a combination of hardware and software.

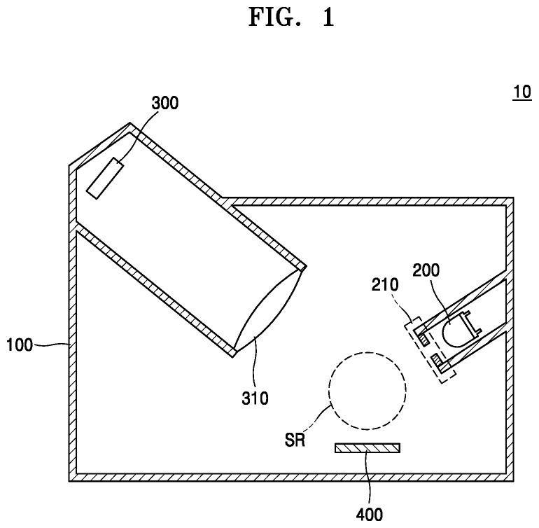

FIG. 1 is a cross-sectional view of a dust sensor according to embodiments.

Referring to FIG. 1, a dust sensor 10 that is a light-scattering dust sensor may include a housing 100, a light emitter 200, an emitted light limiter 210, a light receiver 300, a scattered light focusing lens 310, and a heater 400. The housing 100 may have a shape surrounding the light emitter 200, the emitted light limiter 210, the light receiver 300, and the heater 400. A shape of the housing 100 is illustrative, and the present embodiment is not limited thereto. That is, in other embodiments, the housing 100 may have a shape different from that shown in FIG. 1. The housing 100 may include an opaque material. For example, the housing 100 may include opaque plastic. In embodiments, the housing 100 may further include a metal cover (not shown) surrounding the light receiver 300.

A light scattering region SR may be located in the housing 100. The light scattering region SR may be located between the light emitter 200 and the light receiver 300. The light scattering region SR may be a region where scattered light (not shown) is generated by dust particles (not shown).

The light emitter 200 may emit emitted light (not shown) to the light scattering region SR. For example, the light emitter 200 may include a light-emitting diode (LED). For example, the emitted light may be infrared, visible, or ultraviolet light.

The emitted light limiter 210 may be located between the light emitter 200 and the light scattering region SR. The emitted light limiter 210 may block part of the emitted light and may transmit another part of the emitted light therethrough. In this case, the emitted light limiter 210 may block or transmit the emitted light according to a size of the emitted light. Then, the emitted light may be applied to a part of the light scattering region SR. For example, the emitted light limiter 210 may include a slit structure including a slit having a size less than a width of the emitted light. In another embodiment, the emitted light limiter 210 may include an aperture structure including an aperture having a size less than a width of the emitted light.

The light receiver 300 and the light emitter 200 are located opposite to each other with the light scattering region SR therebetween. The light receiver 300 may measure an intensity of the scattered light generated in the light scattering region SR. The light receiver 300 may be spaced apart from an optical path of the emitted light. Accordingly, the light receiver 300 may not measure the emitted light. That is, the emitted light may not reach the light receiver 300. The light receiver 300 may generate a signal for the intensity of the scattered light and may apply the signal to a controller (not shown). For example, the light receiver 300 may include a phototransistor (TR), a photodiode (PD), a photo IC, or a complementary metal-oxide-semiconductor (CMOS) image sensor (CIS).

The controller may generate data about the amount of the dust particles according to a size of the dust particles based on the signal for the intensity of the scattered light received from the light receiver 300.

The scattered light focusing lens 310 may be located between the light receiver 300 and the light scattering region SR. The scattered light focusing lens 310 may focus the scattered light and may apply the focused light to the light receiver 300. The scattered light focusing lens 310 may be a spherical lens or an aspherical lens.

The heater 400 may heat air and may move dust. For example, the heater 400 may include an electric resistance element.

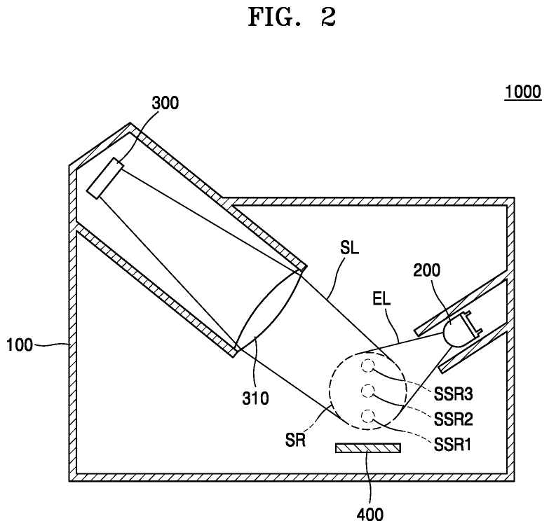

FIG. 2 is a cross-sectional view for describing a driving mode of a dust sensor that does not include an emitted light limiter. For brevity of description, content that is substantially the same as that described with reference to FIG. 1 will not be described.

Referring to FIG. 2, unlike in FIG. 1, a dust sensor 1000 that is a light-scattering dust sensor may not include the emitted light limiter 210 (see FIG. 1).

The light emitter 200 may emit emitted light EL to the light scattering region SR. A width of the emitted light EL may increase away from the light emitter 200. The emitted light EL may include central light adjacent to an optical axis of the emitted light EL and peripheral light surrounding the central light. The central light may have an intensity that is higher and more uniform than that of the peripheral light. That is, an intensity of the peripheral light may be lower and less uniform than that of the central light.

Dust particles (not shown) may be provided into the light scattering region SR. The dust particles may be substantially uniformly distributed in the light scattering region SR. A first sub-light scattering region SSR1, a second sub-light scattering region SSR2, and a third sub-light scattering region SSR3 may be included in the light scattering region SR. The first sub-light scattering region SSR1 may be located adjacent to the heater 400. The third sub-light scattering region SSR3 may be located farther from the heater 400 than the first sub-light scattering region SSR1. The first and third sub-light scattering regions SSR1 and SSR3 may be located in paths of the peripheral light. The second sub-light scattering region SSR2 may be located between the first and third sub-light scattering regions SSR1 and SSR3. The second sub-light scattering region SSR2 may be located in a path of the central light.

The dust particles in the first through third sub-light scattering regions SSR1, SSR2, and SSR3 may convert the emitted light EL into pieces of scattered light SL. For convenience of explanation, the pieces of scattered light SL are illustrated as one scattered light SL. Intensities of the pieces of scattered light SL emitted by the dust particles in the first through third sub-light scattering regions SSR1, SSR2, and SSR3 may be determined by sizes of the dust particles and intensities of pieces of light reaching the dust particles. Since the first and third sub-light scattering regions SSR1 and SSR3 are arranged in the paths of the peripheral light, the dust particles in the first and third sub-light scattering regions SSR1 and SSR3 may be exposed to light having a relatively low intensity. Since the second sub-light scattering region SSR2 is located in the path of the central light, the dust particles in the second sub-light scattering region SSR2 may be exposed to light having a relatively high intensity. When first through third dust particles (not shown) having the same size are respectively provided into the first through third sub-light scattering regions SSR1, SSR2, and SSR3, the pieces of light SL emitted from the first and third dust particles may have intensities lower than that of the scattered light SL emitted from the second dust particles.

The pieces of scattered light SL may be focused by the scattered light focusing lens 310 onto the light receiver 300. The light receiver 300 may measure the pieces of scattered light SL and may generate signals for intensities of the pieces of scattered light.

A controller (not shown) may have matching data between intensities of the pieces of scattered light and sizes of the dust particles. For example, when the intensities of the pieces of scattered light are different from one another, the controller may determine that the sizes of the dust particles corresponding to the pieces of scattered light are different from one another. Since the pieces of scattered light SL emitted from the first and third dust particles have intensities lower than that of the scattered light SL emitted from the second dust particles, the controller may wrongly determine that the first and third dust particles are smaller than the second dust particles. That is, the dust particles provided into the first and third sub-light scattering regions SSR1 and SSR3 may be measured to be smaller than those provided into the second sub-light scattering region SSR2.

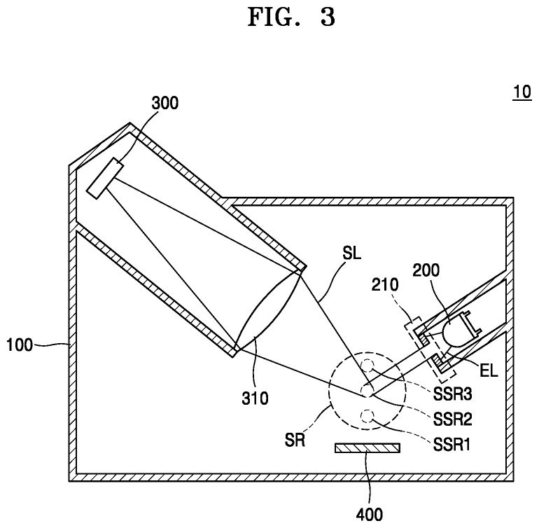

FIG. 3 is a cross-sectional view for describing a driving mode of the dust sensor 10 of FIG. 1. For brevity of description, content that is substantially the same as that described with reference to FIGS. 1 and 2 will not be described.

Referring to FIG. 3, part of the emitted light EL may be blocked by the emitted light limiter 210. The part of the emitted light EL may include peripheral light of the emitted light EL. The emitted light EL may not pass through the third and third sub-light scattering regions SSR1 and SSR3. Dust particles (not shown) in the first and third sub-light scattering regions SSR1 and SSR3 may not be exposed to the emitted light EL. The dust particles in the first and third sub-light scattering regions SSR1 and SSR3 may not emit pieces of scattered light.

Another part of the emitted light EL may pass through the emitted light limiter 210 and may be provided into the light scattering region SR. The other part of the emitted light EL may include central light of the emitted light EL. The emitted light EL may pass through the second sub-light scattering region SSR2. Dust particles in the second sub-light scattering region SSR2 may be exposed to the emitted light EL.

The central light may have a uniform intensity. Accordingly, intensities of pieces of scattered light emitted from the dust particles in the second sub-light scattering region SSR2 may be substantially determined by sizes of the dust particles. In other words, dust particles having the same size in the second sub-light scattering region SSR2 may generate pieces of scattered light having substantially the same intensity.

The light receiver 300 may receive the pieces of scattered light emitted from the dust particles in the second sub-light scattering region SSR2. The light receiver 300 may generate a signal for the intensities of the pieces of scattered light and may apply the signal to a controller.

The controller may receive the signal and may generate data about the amount according to the sizes of the dust particles. Since the intensities of the pieces of scattered light are determined by the sizes of the dust particles, the controller may generate data having high precision and reliability.

The emitted light limiter 210 according to the present disclosure may block part (e.g., the peripheral light) of the emitted light EL so that only part (e.g., the central light) having a uniform intensity from among the emitted light LE emitted by the light emitter 200 is provided into the light scattering region SR. Accordingly, an intensity of the scattered light SL may be determined substantially according to sizes of dust particles. As a result, the precision and reliability of the dust sensor 10 may be improved.

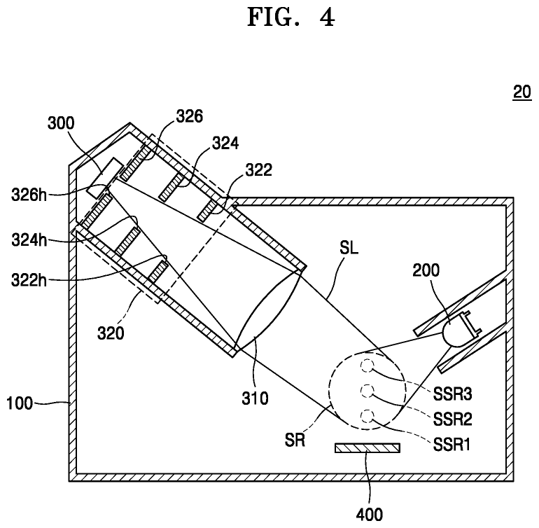

FIG. 4 is a cross-sectional view of a dust sensor according to embodiments. For brevity of description, content that is substantially the same as that described with reference to FIGS. 1 and 2 will not be described.

Referring to FIG. 4, unlike in FIG. 2, a dust sensor 20 that is a light-scattering dust sensor may include a scattered light limiter 320. The scattered light limiter 320 may be located between the light receiver 300 and the scattered light focusing lens 310. The scattered light limiter 320 may block part of the scattered light SL so that the light receiver 300 receives the scattered light SL emitted from a required region in the light scattering region SR. However, for brevity of description, part reaching the light receiver 300 from among the scattered light SL passing through the scattered light focusing lens 310 is illustrated. The required region may be located in a path of central light of the emitted light EL of FIG. 3, and may face a central portion of the scattered light focusing lens 310. For example, the required region may include the second sub-light scattering region SSR2.

The scattered light limiter 320 may include hole structures 322, 324, and 326. Although three hole structures (i.e., the hole structures 322, 324, and 326) are illustrated, the number of the hole structures may be two, or four or more. The hole structures 322, 324, and 326 may be sequentially arranged from the scattered light focusing lens 310 to the light receiver 300. The hole structures 322, 324, and 326 may respectively have holes 322h, 324h, and 326h having different sizes. Sizes of the holes 322h, 324h, and 326h may be reduced toward the light receiver 300. The centers of the holes 322h, 324h, and 326h may be aligned with the center of the light receiver 300 and the center of the scattered light focusing lens 310.

Part of the scattered light SL may be blocked by the scattered light limiter 320. Accordingly, another part of the scattered light SL may be detected by the light receiver 300. The other part of the scattered light SL detected by the light receiver 300 may be emitted by dust particles exposed to the central light of the emitted light EL of FIG. 3. As described with reference to FIG. 3, the central light of the emitted light EL may have a uniform intensity. Accordingly, an intensity of the other part of the scattered light SL may be determined substantially according to sizes of the dust particles. As a result, a controller may generate data having high precision and reliability.

The scattered light limiter 320 according to the present disclosure may block part of the scattered light SL so that the scattered light SL emitted by dust particles exposed to part (e.g., central light) having a uniform intensity from among the emitted light EL emitted by the light emitter 200 is provided to the light receiver 300. Accordingly, an intensity of the scattered light SL reaching the light receiver 300 may be determined substantially according to sizes of the dust particles. As a result, the precision and reliability of the dust sensor 20 may be improved.

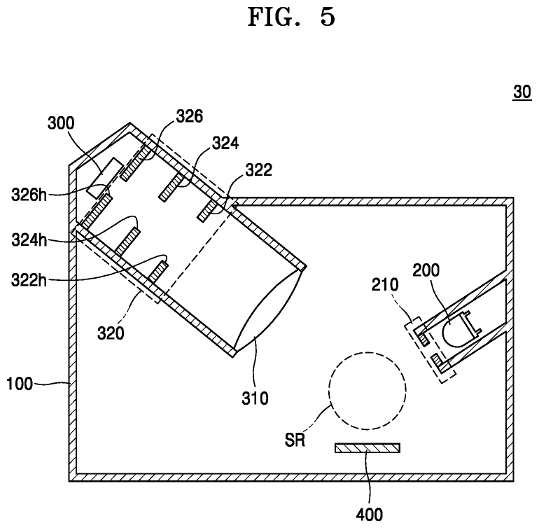

FIG. 5 is a cross-sectional view of a dust sensor according to embodiments. For brevity of description, content that is the same as that described with reference to FIGS. 1 and 4 will not be described.

Referring to FIG. 5, unlike in FIGS. 1 and 4, a dust sensor 30 that is a light-scattering dust sensor may include both the emitted light limiter 210 and the scattered light limiter 320. The emitted light limiter 210 may be substantially the same as the emitted light limiter 210 of FIG. 1. The scattered light limiter 320 may be substantially the same as the scattered light limiter 320 of FIG. 4.

The emitted light limiter 210 according to the present disclosure may block part (e.g., peripheral light) of emitted light so that only part (e.g., central light) having a uniform intensity from among the emitted light emitted by the light emitter 200 is provided into the light scattering region SR. Accordingly, an intensity of the scattered light SL may be determined substantially according to sizes of dust particles.

The scattered light limiter 320 may block part of the scattered light so that pieces of scattered light (not shown) emitted by the dust particles exposed to the part of the emitted light having a uniform intensity are provided to the light receiver 300. Accordingly, an intensity of the scattered light reaching the light receiver 300 may be determined substantially according to sizes of the dust particles.

As a result, the precision and reliability of the dust sensor 30 may be improved.

According to the present disclosure, since a region where scattered light is generated is limited, the precision of a dust sensor may be improved.

According to the present disclosure, since a light-receiving region is limited, the precision of a dust sensor may be improved.

However, the effect of the present disclosure is not limited thereto.

While the present disclosure has been particularly shown and described with reference to embodiments thereof, the embodiments have been used to explain the present disclosure and should not be construed as limiting the scope of the present disclosure defined by the claims. Accordingly, it will be understood by one of ordinary skill in the art that various changes in form and details may be made therein without departing from the spirit and scope of the present disclosure as defined by the following claims.

What is claimed is:

1. A light-scattering dust sensor comprising:
a light scattering region:
a light emitter configured to emit light to the light scattering region;
a light receiver configured to receive scattered light generated in the light scattering region; and
an emitted light limiter located between the light emitter and the light scattering region,
wherein the light emitted by the light emitter comprises:
peripheral light; and
central light having an intensity that is more uniform than an intensity of the peripheral light,
wherein the emitted light limiter is configured to block part of the emitted light,
wherein the part of the emitted light blocked by the emitted light limiter comprises the peripheral light.

2. The light-scattering dust sensor of claim 1, wherein the emitted light limiter comprises a slit or an aperture.

3. The light-scattering dust sensor of claim 2, wherein the slit or the aperture has a size equal to or less than a width of the central light.

4. The light-scattering dust sensor of claim 3, wherein the light emitter comprises a light-emitting diode (LED).

5. The light-scattering dust sensor of claim 4, wherein the width of the central light is equal to or less than a width of light determined by a half angle of the LED.

6. The light-scattering dust sensor of claim 1, further comprising a scattered light limiter located between the light receiver and the light scattering region,
wherein the scattered light limiter is configured to block part of the scattered light, and
the light receiver is further configured to detect another part of the scattered light.

7. The light-scattering dust sensor of claim 6, wherein the scattered light limiter comprises a plurality of hole structures sequentially arranged from the light scattering region to the light receiver,
wherein the plurality of hole structures respectively comprise a plurality of holes having different sizes.

8. The light-scattering dust sensor of claim 7, wherein, from among the plurality of holes, a hole adjacent to the light receiver is smaller than a hole adjacent to the light scattering region.

9. The light-scattering dust sensor of claim 8, wherein the plurality of holes are three holes.

10. The light-scattering dust sensor of claim 9, further comprising a scattered light focusing lens located between the scattered light limiter and the light scattering region,
wherein the scattered light focusing lens is configured to focus the scattered light such that the focused light is provided to the receiver.

11. The light-scattering dust sensor of claim 10, further comprising a heater configured to generate heat and thereby move dust particles.
